(19) United States
(12) Patent Application Publication
(10) Pub. No.: US 2013/0026716 A1
(43) Pub. Date: Jan. 31, 2013

(54) Sealing Connection Between a Receptacle and a Connecting Body

(71) Applicants: Olaf Nahrwold, Ludwigshafen (DE); Stefan Schirmer, Lehrte (DE); Rainer Knorr, Berlin (DE); Christian Ziegler, Bad Kissingen (DE); Frank Birkwald, Ostfildern (DE); Frank Blaszyk, Bietigheim-Bissingen (DE)

(72) Inventors: Olaf Nahrwold, Ludwigshafen (DE); Stefan Schirmer, Lehrte (DE); Rainer Knorr, Berlin (DE); Christian Ziegler, Bad Kissingen (DE); Frank Birkwald, Ostfildern (DE); Frank Blaszyk, Bietigheim-Bissingen (DE)

(73) Assignee: CARL FREUDENBERG KG, THYSSENKRUPP PRESTA AG

(21) Appl. No.: 13/550,993

(22) Filed: Jul. 17, 2012

(30) Foreign Application Priority Data
Jul. 29, 2011 (EP) 11 006 274.2

(51) Int. Cl. F16J 15/02; B32B 37/08; B32B 37/06

(52) U.S. Cl. 277/634; 156/293; 277/628

(57) ABSTRACT

An arrangement including a receptacle part (1) and a connecting body (2), wherein the connecting body (2) has a base body (3) having an inside surface (5) which is in contact with an outer surface (6) of the receptacle part (1). The base body (3) includes a thermoplastic elastomer connected to the outer surface (6) of the receptacle part (1). The outer surface (6) is designed to be rough enough so that the thermoplastic elastomer will enter into a form-fitting connection and/or an adhesive bond with the outer surface (6) after softening and then solidification.

### CROSS-REFERENCE TO RELATED APPLICATIONS

This application claims the benefit and priority of European Application No. 11 006 274.2, filed Jul. 29, 2011. The entire disclosure of the above application is incorporated herein by reference.

### FIELD

The invention relates to an arrangement for providing a clampless sealing connection between a receptacle and a connecting body.

### BACKGROUND

US 2007/0178978 A1 discloses a bellows arrangement which is provided with clamping areas at connecting points and is pressed against the receiving part of a steering gear. In the aforementioned arrangement it is a disadvantage that a reinforcing element which must be applied in the end areas of the bellows must supply the required prestress over the entire temperature range of an application in the automotive field and must maintain the clamping function with a corresponding area of the receptacle part. This is true in particular since the reinforcing elements make it more expensive to manufacture the component.

DE 102 11 881 A1 discloses an arrangement in which a receptacle part is provided with a dovetailed groove. A thermoplastic elastomer of a bellows is held in this groove in a form-fitting seal.

The thermoplastic elastomer of the bellows is heated so that it flows into the dovetailed groove and forms a form-fitting connection with it after it solidifies.

One disadvantage of the arrangement described above is that the outside surface of the receptacle part must be provided with a dovetailed groove. For metallic receptacle parts, this requires machining. Creating the dovetailed groove requires additional operations and therefore generates costs.

Another disadvantage is that the receptacle part must have a certain wall thickness to be able to receive a dovetailed groove of a defined depth. However, a relatively great wall thickness leads to an increased weight of the arrangement. Furthermore, more installation space is also necessary with an increase in the wall thickness of the receptacle part.

As soon as a receptacle part having a relatively small wall thickness is to be connected to a connecting body, for example, a bellows or tubing, clamps or belts must also be used. When using thermoplastic elastomers, ear clamps, screw clamps, multi-crimp rings or cable ties are currently being used.

Clamping results in stresses in the material of which the connecting body is manufactured. These stresses are necessary to establish the required sealing effect but they lead to creep or settling of the polymer materials that are used.

In this way, the required stresses on the sealing sites can be weakened substantially in some cases during operation. There is the risk that a seal is no longer ensured. There is also the risk that the clamps may become completely loosened and the connecting body can slip away from the receptacle part.

The technical problems mentioned above occur on steering gears to which bellows are attached in particular.

The clamps currently in use take up a comparatively large amount of space and have a relatively great weight in relation to the connecting body. Moreover, clamps are relatively expensive and cause a substantial expense in acquisition, storage shipping and assembly.

### SUMMARY

The present disclosure therefore provides an arrangement for connecting a receptacle part to a connecting body, wherein clamps or belts may be omitted and wherein complex machining of the outer surface of the receptacle part is not necessary.

According to the present disclosure, it has been recognized that a form-fitting connection can be established between a receptacle part and a connecting body not only by macroscopic structures such as grooves but also by microscopic structures. In experiments it has surprisingly been found that an additional adhesive effect occurs with a suitable choice of materials and/or modification of the material and with adequate heating. This adhesive effect corresponds to an adhesive bond but without the use of adhesive.

In concrete terms, it has been recognized here that the roughness of an unmachined outer surface of a receptacle part may itself be sufficient alone to enter into a form-fitting bond with a thermoplastic elastomer. In addition or as an alternative to a form-fitting connection, adhesive effects also occur, facilitating a sealing connection of the connecting body. In particular the active surface for adhesive effects is increased by the roughness.

Against this background, for example, it is conceivable that deep-drawn die-cast or sand-cast receptacle parts would be bonded together in a form-fitting manner with a thermoplastic elastomer. Furthermore, it has been recognized that it is possible to eliminate belts or clamps by utilizing the characteristic roughness of a receptacle part. To this extent, stresses in the connecting body are greatly reduced or are eliminated. Due to the elimination of the clamps or belts, this saves on weight, installation space and costs.

The outer surface could have a roughness RZ in the range of 10 μm to 250 μm. It has surprisingly been found that a receptacle part having a roughness within this range will enter into a very stable form-fitting connection and/or an adhesive bond with a thermoplastic elastomer. The connection between the receptacle part and the connecting body is so strong that the connecting body will withstand substantial tensile forces.

This ensures that a form-fitting connection between the receptacle part and the connecting body can be established without the use of additional adhesives. The substances already contained in the thermoplastic elastomer are used to form the bond. To this extent, environmentally friendly production of the aforementioned arrangement is made possible.

Against this background, the outer surface cannot have undergone any machining in the area in which it is bonded to the thermoplastic elastomer. In particular there should not be any grooves, mill cuts, beveled edges or macroscopic undercuts. Therefore, receptacle parts having only a small wall thickness can be used. The wall thickness of the receptacle part need not have a certain depth to receive the grooves. The outer surface of the receptacle parts must only have a certain roughness to be able to establish a form-fitting connection or an adhesive bond with the thermoplastic elastomer.

The connecting body may be connected to the outer surface in a fluid-tight seal. It has surprisingly been recognized that a thermoplastic elastomer can be bonded to the rough structure of an outer surface so that a fluid-tight and/or gas-tight seal of the interior of the connecting body is made possible.

The form-fitting connection and/or the adhesive bond of the thermoplastic elastomer to the outer surface could be established by partial melting and subsequent solidification of the thermoplastic elastomer. For this specific embodiment, the basic body of the connecting body and/or the receptacle part can be heated so that the thermoplastic elastomer of which the basic body is made at least in part will melt. The molten areas of the thermoplastic elastomer may then penetrate into the rough structures of the outer surface of the receptacle part and flow behind them. On solidification of the thermoplastic elastomer, a form-fitting connection and/or an adhesive bond which connect(s) the receptacle part to the base body in a secure and fluid-tight seal.

Against this background the connecting body could be embodied as bellows. Bellows can be compressed or expanded axially with no problem. Moreover, bellows are used in a variety of couplings, joints and steering gears.

The connecting body could be embodied as a tube. Tubes may be used in the air ducts or hydraulic systems of engines and motors.

Use of an arrangement such as that described here in a steering gear is especially advantageous because a fluid and dust-tight delineation with respect to the environment is possible. This is possible while minimizing costs and installation space.

One method for producing an arrangement of the type described here could include the following steps:

Providing a receptacle part and a connecting body with a base body, applying the base body to the receptacle part, heating the base body so that its thermoplastic elastomer is softened and can penetrate into rough structures on the outer surface of the receptacle part, solidification of the thermoplastic elastomer so that thermoplastic elastomer in the rough structures solidifies and enters into a form-fitting connection and/or an adhesive bond with the outer surface.

The heating of the base body could take place via the outer surface from the inside. It is conceivable here for the process heat to be introduced through electrical induction into a metallic receptacle part in order to partially melt the thermoplastic elastomer.

Heating of the base body could be accomplished at a temperature above the Vicat softening point but below the decomposition temperature of the thermoplastic elastomer. The process heat may be introduced through thermal radiation, in particular by radiant lamps or heat mirrors. The thermoplastic elastomer of which the base body is at least partially made can be partially melted in this way.

The base body might be heated at a temperature which is in the range of the decomposition temperature of the thermoplastic elastomer.

The base body could be pressed radially from the outside against the outer surface to establish the form-fitting connection and/or the adhesive bond. After applying the base body for the receptacle part, the base body can be pressed against the receptacle part in the radial direction. Against this background it is conceivable that the base body may be applied to the receptacle part by pulling the receptacle part over the base body.

The receptacle part and the connecting body may overlap in such a way that the resolving prestress is sufficient to establish the form-fitting connection and/or the adhesive bond. It is concretely conceivable here that the inside diameter of the base body is in the range of the outside diameter of the receptacle part. There could be an adjustment in the play up to an excess dimension.

There are various possibilities for embodying and improving upon the teaching of the present disclosure in advantageous ways. Reference in this regard is made to the subordinate claims on the one hand and to the following explanation of a preferred exemplary embodiment of the inventive arrangement on the basis of the drawings on the other hand.

Preferred embodiment and refinements of the teaching are generally explained in conjunction with the explanation of the preferred exemplary embodiment with reference to the drawings.

### DRAWINGS

The FIGURE shows an arrangement in which bellows are connected to a cylindrical receptacle part merely by a form-fitting connection and/or an adhesive bond between the thermoplastic elastomer of the bellows and the outer surface of the receptacle part.

### DETAILED DESCRIPTION

The FIGURE shows an arrangement comprising a receptacle part 1 and a connecting body 2, wherein the connecting body 2 has a base body 3 with an open cylindrical collar 4 such that the collar 4 is connected to the receptacle part 1 and the collar 4 has an inner surface 5 which is in contact with an outer surface 6 of the receptacle part 1 such that the base body 3 comprises a thermoplastic elastomer and the thermoplastic elastomer is connected to the outer surface 6 of the receptacle part 1.

To this extent, the arrangement comprises a receptacle part 1 and a connecting body 2 wherein the connecting body 2 has a base body 3 such that the base body 3 is connected to the receptacle part 1 and the base body 3 has an inner surface 5 which in contact with the outer surface 6 of the receptacle part 1, wherein the base body 3 comprises a thermoplastic elastomer and the thermoplastic elastomer is bonded to the outer surface 6 of the receptacle part 1.

The outer surface 6 is designed to be rough so that the thermoplastic elastomer enters into a form-fitting connection and/or an adhesive bond with the outer surface 6 after softening and solidifying.

The outer surface 6 has a roughness RZ in the range of 10 μm to 250 μm.

The outer surface 6 is preferably not machined so as to have an as-formed roughness. Machining to achieve the required roughness is not ruled out however. For example, a rough grinding process or knurling may be performed.

The receptacle part 1 is designed as a cylindrical component. It may be designed as a deep-drawn component, a die-cast component or as a sand-cast component, for example, having an as-formed roughness. Thus a microscopic form-fitting connection with the thermoplastic elastomer is possible.

There is not a physically bonded connection between the thermoplastic elastomer and the outer surface 6 due to the use of an additional adhesive. The outer surface 6 of the receptacle part 1 has preferably not been machined in the area in which it is bonded to the thermoplastic elastomer.

The connecting body 2 is bound to the outer surface 6 in a fluid-tight seal. The form-fitting connection and/or the adhesive bonding of the thermoplastic elastomer to the outer surface 6 is/are established by partial melting and subsequent solidification of the thermoplastic elastomer.

The thermoplastic is preferably selected from the material families of TPCEE and TPV. TPCEE stands for “thermoplastic copolymer ether ester.” TPV stands for “thermoplastic vulcanizate,” which generally refers to a polypropylene-EPDM mixture with a highly crosslinked EPDM phase. EPDM stands for ethylene-propylene-diene rubber.

The connecting body 2 can be designed as bellows and has multiple folds. The connecting body 2 can be compressed in the axial direction.

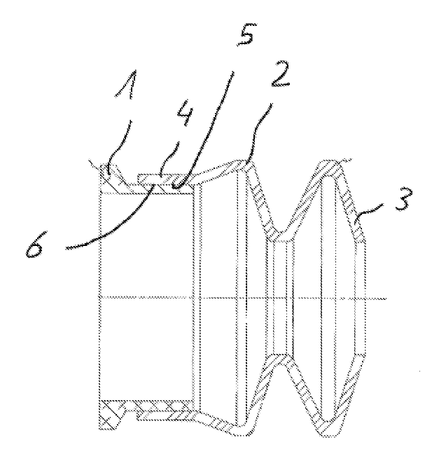

The arrangement according to FIG. 1 was produced by a method comprising the following steps:

Providing a receptacle part 1 and a connecting body 2 with a base body 3, applying the base body 3 to the receptacle part 1, heating the base body 3 so that its thermoplastic elastomer is softened and can penetrate into rough structures on the outer surface 6 of the receptacle part 1, solidification of the thermoplastic elastomer so that the thermoplastic elastomer in the rough structures solidifies and enters into a form-fitting connection and/or an adhesive bond with them.

The heating of the base body 3 is accomplished from the inside via applying heat to receptacle part 1 for heating the outer surface 6. Heating of the base body 3 is accomplished at a temperature above the Vicat softening point but below the decomposition temperature of the thermoplastic elastomer.

The heating of the base body 3 may occur at a temperature in the range of the decomposition temperature of the thermoplastic elastomer.

The base body 3 is pressed radially from the outside against the outer surface 6 to establish the form-fitting connection and/or the adhesive bond.

The receptacle part 1 and the connecting body 2 overlap so that a prestress resulting from this is sufficient to establish the form-fitting connection and/or the adhesive bond.

The arrangement according to FIG. 1 was established in concrete terms by a method comprising the following steps:

Providing the receptacle part 1 and the connecting body 2 with a collar 4, applying the collar 4 to the receptacle part 1, heating the collar 4 so that its thermoplastic elastomer is softened and can penetrate into rough structures of the outer surface 6 of the receptacle part 1 and pooling of the thermoplastic elastomer so that the thermoplastic elastomer in the rough structures solidifies and creates a form-fitting connection and/or an adhesive bond with it.

With regard to additional advantageous embodiments and refinements of the inventive teaching, reference is made on the one hand to the general part of the description and on the other hand to the accompanying patent claims.

What is claimed is:

1. An arrangement, comprising:
a receptacle part (1) having an outer surface (6); and
a connecting body (2) having a base body (3) connected to the receptacle part (1), wherein the base body (3) has an inside surface (5) which is in contact with the outer surface (6) of the receptacle part (1), wherein the base body (3) comprises a thermoplastic elastomer connected to the outer surface (6) of the receptacle part (1):
wherein the outer surface (6) of the receptacle part (1) is rough enough so that the thermoplastic elastomer is in a form-fitting connection and/or an adhesive bond with the outer surface (6) after softening and then solidification.

2. The arrangement according to claim 1, wherein the outer surface (6) has a roughness RZ in the range of 10 μm to 250 μm.

3. The arrangement according to claim 1, wherein a connection between the thermoplastic elastomer and the outer surface (6) is free from an additional adhesive.

4. The arrangement according to claim 1, wherein the outer surface (6) is free from machining in the area in which it is bonded to the thermoplastic elastomer.

5. The arrangement according to claim 1, wherein the connecting body (2) is bound in a fluid-tight seal to the outer surface (6).

6. The arrangement according to claim 1, wherein the form-fitting connection and/or the adhesive bond of the thermoplastic elastomer to the outer surface (6) is established by partial melting and then solidification of the thermoplastic elastomer.

7. The arrangement according to claim 1, wherein the connecting body (2) is designed as bellows.

8. The arrangement according to claim 1, wherein the connecting body (2) is designed as a tube.

9. The arrangement according to claim 1, wherein the receptacle part (1) and the connecting body (2) are components of a steering gear assembly.

10. A method for producing an arrangement comprising the steps of:
providing a receptacle part (1) and a connecting body (2) with a base body (3), applying the base body (3) to the receptacle part (1), heating the base body (3) so that its thermoplastic elastomer is softened and can penetrate into rough structures on the outer surface (6) of the receptacle part (1), cooling of the thermoplastic elastomer to solidification, such that the thermoplastic elastomer, which has penetrated into the rough structures, enters into a form-fitting connection and/or an adhesive bond with the outer surface (6) on solidification.

11. The method according to claim 10, wherein the base body (3) is heated from the inside via the outer surface (6).

12. The method according to claim 10, wherein the base body (3) is heated to a temperature above the Vicat softening temperature but below the decomposition temperature of the thermoplastic elastomer.

13. The method according to claim 10, wherein the base body (3) is heated at a temperature which is in the range of the decomposition temperature of the thermoplastic elastomer.

14. The method according to claim 10, wherein the base body (3) is pressed radially from the outside against the outer surface (6) to establish the form-fitting connection and/or the adhesive bond.

15. The method according to claim 10, wherein the receptacle part (1) and the connecting body (2) overlap in such a way that the resulting prestress is sufficient to establish the form-fitting connection and/or the adhesive bond.
